(19) United States
(12) Patent Application Publication
(10) Pub. No.: US 2010/0264205 A1
(43) Pub. Date: Oct. 21, 2010

(54) NUTRITIONAL COMPONENT DISPLAY APPARATUS, SHOPPING CART AND NUTRITIONAL COMPONENT DISPLAY METHOD

(75) Inventor: Shuuichi Iida, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/756,484

(22) Filed: Apr. 8, 2010

(30) Foreign Application Priority Data
Apr. 15, 2009 (JP) 2009-099088

(51) Int. Cl. G06F 17/00

(52) U.S. Cl. 235/375

(57) ABSTRACT

By a wireless communication unit, from a wireless tag attached to an article located within a communication area of the wireless communication unit, information about the article is read. On the basis of the information read from the wireless tag by the wireless communication unit, nutritional component information of the article to which the wireless tag is attached is specified. The specified nutritional component information is displayed on a display unit.

### CROSS-REFERENCE TO RELATED APPLICATION

This application is based upon and claims the benefit of priority from the prior Japanese Patent Application No. 2009-099088, filed Apr. 15, 2009, the entire contents of which are incorporated herein by reference.

### TECHNICAL FIELD

The present invention relates to a nutritional component display apparatus, a shopping cart and a nutritional component display method for displaying nutritional components of food products sold in a supermarket or the like.

### BACKGROUND

Conventionally, in a store where food products are sold such as a supermarket, shopping baskets and shopping carts to which these shopping baskets can be attached are prepared in order to realize convenience so that customers can easily carry articles to be purchased.

Various inventions for providing customers with useful information for shopping are made in order to improve convenience in shopping. For example, an information providing apparatus disclosed in JPA-2005-108180 provides a display unit on the shopping cart to which the shopping basket is attached and information or the like related to articles is displayed on the display unit in accordance with the position where the shopping cart passes.

Recently, in response to the enhanced public awareness of health in Japan, nutritional component information including calories and various nutrients has increasingly large influence on customers' selection of food products. Some customers even total calories of food products while shopping.

It is troublesome for customers to confirm the labeling of nutritional components of articles to be purchased and total the information of nutritional components each time in this manner. Moreover, when many customers come to the store, a delay in selection of articles to be purchased may cause more crowding in the store.

### SUMMARY

In view of the foregoing circumstances, it is an object of the invention to provide a nutritional component display apparatus, a shopping cart and a nutritional component display method that enable customers to easily grasp nutritional components and their total value of each food product that the customers want to purchase.

A nutritional component display apparatus according to an aspect of the invention includes: a wireless communication unit which reads, from a wireless tag attached to an article located within a communication area, information about the article via wireless communication; an information specifying unit which specifies nutritional component information of the article to which the wireless tag is attached, on the basis of the information read from the wireless tag by the wireless communication unit; and a display unit which displays the nutritional component information specified by the information specifying unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a shopping cart to which a nutritional component display apparatus is attached according to an embodiment of the invention.

FIG. 2 is a block diagram showing a control circuit of the nutritional component display apparatus in the embodiment.

FIG. 3 shows an example of data structure of a reading data file in the embodiment.

FIG. 4 is a flowchart showing the processing executed by a CPU in the embodiment.

FIG. 5 shows an example of a nutritional component display in the embodiment.

### DETAILED DESCRIPTION

Hereinafter, an embodiment of the invention will be described with reference to the drawings. This embodiment is an example in which a nutritional component display apparatus as an embodiment of the invention is attached to and used on a shopping cart used in a store where food products are sold such as a supermarket.

FIG. 1 is a schematic perspective view of a shopping cart 1. The shopping cart 1 has a frame 2 including a handle and the like. Four casters 3 (traveling parts) are attached to lower parts of the frame 2. These casters 3 enable the shopping cart 1 to travel back and forth, and left and right. A shopping basket 4 (housing part), a display control unit 5 (display unit) and an RFID (radio frequency identification) reader 6 (wireless communication unit) are attached to the upper parts of the frame 2. The display control unit 5 and the RFID reader 6 constitute the nutritional component display apparatus according to this embodiment.

The shopping basket 4 is removably attached to the frame 2 and has an opening in which articles can be put from above.

The display control unit 5 has a display 7 such as LCD (liquid crystal display) integrally attached to a control panel.

The RFID reader 6 has an antenna, a modulating unit and a demodulating unit. The antenna sends out a high-frequency signal as a radio wave and also outputs a received radio wave as a high-frequency signal. The modulating unit modulates a predetermined digital signal to a high-frequency signal and outputs the high-frequency signal to the antenna. The demodulating unit demodulates the high-frequency signal outputted by the antenna to a digital signal. The radio wave sent out from the antenna is oriented in the direction of attachment of the shopping basket 4. The RFID reader 6 performs wireless communication with an RFID tag existing within a range where communication is possible via the radio wave sent out from the antenna.

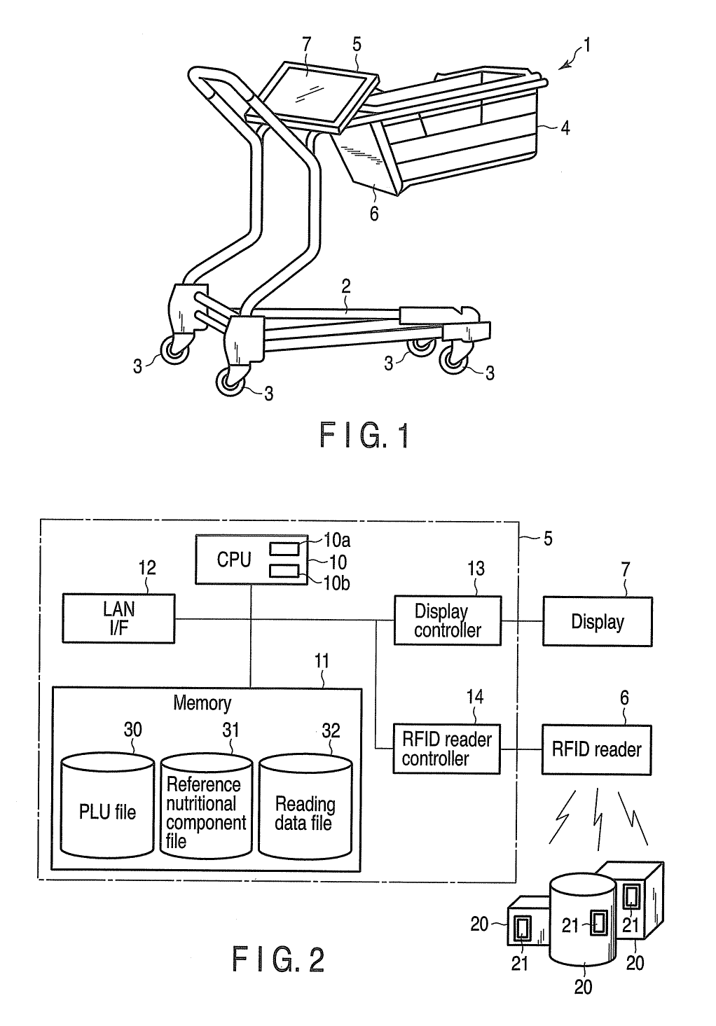

FIG. 2 is a block diagram showing a control circuit of the nutritional component display apparatus. The display control unit 5 has a CPU 10 functioning as a control center. A memory 11, a LAN interface (I/F) 12, a display controller 13 and an RFID reader controller 14 are connected to the CPU 10. Moreover, the display 7 is connected to the display controller 13 and the RFID reader 6 is connected to the RFID reader controller 14. Thus, the control circuit of the nutritional component display apparatus is configured.

The memory 11 includes a ROM (read only memory), RAM (random access memory) or the like.

The LAN interface 12 controls communication with an external device that is carried out via a LAN (local area network) cable or the like.

The display controller 13 controls the display 7 and thus causes the display 7 to display various kinds of information.

The RFID reader controller 14 controls wireless communication by the RFID reader 6 with the RFID tag.

An RFID tag 21 as a wireless tag having an IC and an antenna is attached to a food product 20 sold in this store. In the IC of the RFID tag 21, a unique tag code allocated to each RFID tag 21, a PLU (price lookup) code of the food product 20 as an attachment target, and nutritional component information including calories, protein, fat, carbohydrate and salt of the food product 20 are stored.

When the food product 20 is housed in the shopping basket 4, the RFID reader 6 carries out wireless communication via radio waves with the RFID tag 21 attached to the food product 20 and reads the tag code, the PLU code and the nutritional component information.

The intensity of radio waves emitted from the RFID reader 6 is adjusted to set a communication-enabled area so that the RFID reader 6 carries out wireless communication only with the RFID tag 21 attached to the food product 20 housed in the shopping basket and does not carry out wireless communication with the RFID tag 21 attached to the food product 20 laid out in the store.

In the memory 11, a PLU file 30, a reference nutritional component file 31, and a reading data file 32 are stored.

In the PLU file 30, the name of the food product 20 is stored correspondingly to the PLU code of the food produce 20 sold in the store. The PLU file 30 becomes updated when the nutritional component display apparatus is connected to a higher-order device via the LAN interface 12 in order to deal with changes in the type of the food products 20 sold in the store.

In the reference nutritional component file 31, a reference value of each nutritional component that should be taken per day by an adult male and a reference value of each nutritional component that should be taken per day by an adult female are stored.

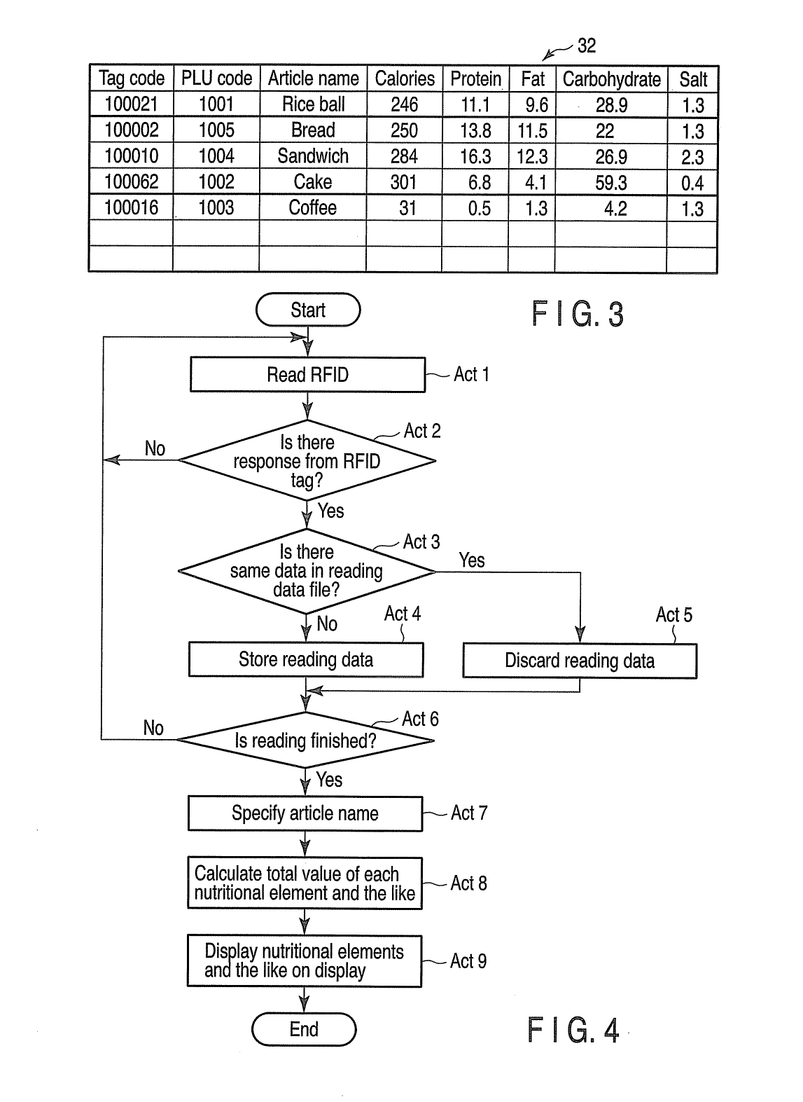

FIG. 3 shows an example of data structure of the reading data file 32. The reading data file 32 includes storage areas for tag code, PLU code, article name, calories, protein, fat, carbohydrate, and salt.

In the storage areas for tag code, PLU code, calories, protein, fat, carbohydrate, and salt, information about the tag code, PLU code, calories, protein, fat, carbohydrate, and salt read from the RFID tag 21 is stored, respectively. In the storage area for article name, an article name specified from the PLU file 30 on the basis of the PLU code stored in the storage area for PLU code is stored.

The CPU 10 has an information specifying section 10a and a calculation section 10b. The functions of the information specifying section 10a and the calculation section 10b are realized by executing an operation program stored in the memory 11.

The information specifying section 10a specifies the nutritional component information of the article to which the RFID tag 21 is attached, on the basis of the information read from the RFID tag 21 by the RFID reader 6.

If information is read from plural RFID tags 21 by the RFID reader 6 and the nutritional component information of the article is specified by the information specifying section 10a on the basis of the information read from the plural RFID tags 21, the calculation section 10b calculates the total value of numeric values for the same component, among numeric values indicated by the respective pieces of nutritional component information.

Next, the operation of the nutritional component display apparatus will be described specifically.

FIG. 4 is a flowchart of the processing executed by the CPU 10 when a customer uses the shopping cart 1. This processing is executed periodically in predetermined timing. At the beginning, the storage content in the reading data file 32 is initialized.

First, the CPU 10 controls the RFID reader 6 via the RFID reader controller 14 and tries reading an RFID tag 21 located in the shopping basket 4 (Act 1). After trying reading the RFID tag 21, the CPU 10 determines whether there is a response from the RFID tag 21 or not (Act 2). If no food product 20 is housed in the shopping basket 4, no response from the RFID tag 21 is given (No in Act 2). In this case, the CPU 10 waits for the lapse of a predetermined time and then controls the RFID reader 6 again to try reading an RFID tag 21 (Act 1).

Meanwhile, if a food product 20 is housed in the shopping basket 4, a response is given from the RFID tag 21 attached to this food product (Yes in Act 2). In this case, the CPU 10 determines whether the same tag code as a tag code acquired as a result of demodulating a high-frequency signal based on the response radio wave from the RFID tag 21 is stored in the reading data file 32 or not (Act 3).

If the same tag code is stored, it means that the reading of this RFID tag 21 is already completed (Yes in Act 3). Therefore, the CPU 10 discards the reading data about this tag code (Act 5). Meanwhile, if the same tag code is not stored, the reading of this RFID tag 21 is not completed yet (No in Act 3). Therefore, the reading data about the tag code is stored in the reading data file 32 (Act 4).

After the operation of Act 4 or Act 5, the CPU 10 determines whether the reading of the RFID tag 21 is completed or not (Act 6). This determination is made, for example, on the basis of the number of trials of reading in Act 1 or the elapsed time after the reading is started. The number of trials can be counted if a counter is generated in a registered provided in the memory 11 or the CPU 10 and the count value of the counter is incremented every time the operation of Act 1 is executed. The elapsed time can be measured by making a timer provided in the CPU 10 operate in timing when the operation of Act 1 is executed for the first time.

If such criteria for determination are used, the CPU 10 determines that the reading of the RFID tag 21 is not completed if the reading of the RFID tag 21 is not tried a predetermined number of times or more, or if there is not a predetermined elapsed time after the start of the trial (No in Act 6). If it is determined that the reading of the RFID tag 21 is not completed, the CPU 10 waits for the lapse of a predetermined time and then controls the RFID reader 6 again to try reading the RFID tag 21 (Act 1).

Meanwhile, if the reading of the RFID tag 21 is tried a predetermined time or times or more, or if there is a predetermined elapsed time after the start of the trial, the CPU 10 determines that the reading of the RFID tag 21 is completed (Yes in Act 6). If it is thus determined that the reading of the RFID tag 21 is completed, the CPU 10 specifies an article name corresponding to each PLU code stored in the reading data file 32, from the PLU file 30 (Act 7). The article name specified at this time is stored in the storage area for article name corresponding to each PLU code in the reading data file 32.

After specifying the article name, the CPU 10 calculates the total value of numeric values corresponding to each article with respect to each of nutritional components (calories, protein, fat, carbohydrate, and salt) stored in the reading data file 32 (Act 8). The total value calculated for each nutritional component is stored in a work storage area formed in the memory 11.

The CPU 10 then controls the display 7 via the display controller 13 and displays, on the display 7, the name or nutritional components of each food product stored in the reading data file 32, the total value of numeric values for each nutritional component stored in the memory 11 in the operation of Act 8 and the reference values of each nutritional component that should be taken per day by an adult male and by an adult female, stored in the reference nutritional component file 31 (Act 9). Thus, the CPU 10 ends the series of processing.

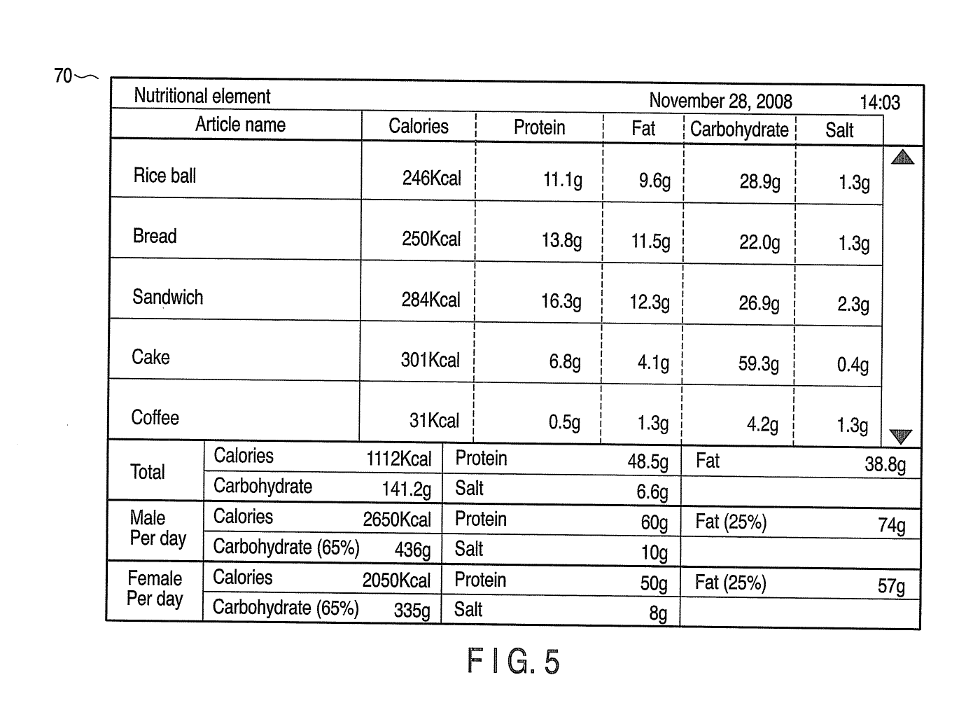

FIG. 5 is a schematic view showing an example of a display screen 70 of the display 7 on which the nutritional components and the like based on the reading data stored in the reading data file 32 shown in FIG. 3 are displayed.

The display screen 70 has display areas for article name, calories, protein, fat, carbohydrate, and salt. In Each display area, nutritional components included in the reading data for the articles names “rice ball”, “bread”, “sandwich”, “cake”, and “coffee” stored in the reading data file 32 are displayed. A scroll bar is provided near the display areas for nutritional components. As the scroll bar is operated by touch, the display areas can be scrolled up and down for browsing. Therefore, even if many food products are housed in the shopping basket 4, the nutritional components of all the food products can be browsed.

Moreover, below the display areas for nutritional components of each food product, a display area for the total value of nutritional components of each food product and display areas for the reference values of each nutritional component that should be taken per day by an adult male and by an adult female are provided. In the display area for the total value, the total value for each nutritional component calculated by the CPU 10 in the operation of Act 8 is displayed. In the display areas for the reference values, the reference values for each nutritional component stored in the reference nutritional component file 31 are displayed separately as the reference value for male and the reference value for female.

As described above, the nutritional component display apparatus according to this embodiment automatically reads nutritional components of a food product housed in the shopping basket 4 and displays the contents of the nutritional components. Therefore, the customer can easily grasp the nutritional components simply by browsing the display screen of the display 7 without having to take each food product in hand, search for the part on its package where a nutritional component labeling or the like is placed, and then confirm its content.

If plural food products are housed in the shopping basket 4, the total value of nutritional components of each food product is automatically calculated and displayed. Therefore, the customer can easily grasp the total value of nutritional components of the food products that the customer wants to purchase, without calculating the total value by himself or herself.

The display of nutritional components or the like also includes the reference values of each nutritional component that should be taken per day. The customer can select food products to be purchased while watching the display and making a comparison with the reference values. Moreover, the reference values of each nutritional component that should be taken per day are displayed separately for male and female. Therefore, the customer can be informed of accurate reference values corresponding to male or female.

In the embodiment, the case where the nutritional component display apparatus as an embodiment of the invention is attached to a shopping cart is described. However, the nutritional component display apparatus need not necessarily be attached to a shopping cart. The apparatus may be attached to and used in a shopping basket that the customer carries. Also, the nutritional component display apparatus may be attached to a shopping cart and a shopping basket may be attachable to and removable from the shopping cart.

Nutritional components that form nutritional component information are not limited to calories, protein, fat, carbohydrate, and salt, and may include other nutritional components such as vitamins or the like.

Instead of storing nutritional component information in the RFID tag 21, the nutritional component information may be stored correspondingly to a PLU code, in the PLU file 30. In this case, by searching the PLU file 30 for the nutritional component information corresponding to the PLU code read by the RFID reader 6, it is possible to specify the nutritional component information of each article.

Also, data stored in the reference nutritional component file 31 are not limited to the reference values of each nutritional component that should be taken per day by an adult male and by an adult female, and may include other reference values.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A nutritional component display apparatus comprising:
a wireless communication unit which reads, from a wireless tag attached to an article located within a communication area, information about the article via wireless communication;
an information specifying unit which specifies nutritional component information of the article to which the wireless tag is attached, on the basis of the information read from the wireless tag by the wireless communication unit; and
a display unit which displays the nutritional component information specified by the information specifying unit.

2. The apparatus according to claim 1, wherein the information read from the wireless tag by the wireless communication unit includes nutritional component information, and
the information specifying unit specifies the nutritional component information included in information read from the wireless tag by the wireless communication unit, as the nutritional component information of the article to which the wireless tag is attached.

3. The apparatus according to claim 1, further comprising a calculation unit which, if information is read from plural wireless tags by the wireless communication unit and nutritional component information of articles based on the information read from the plural wireless tags is specified by the information specifying unit, calculates a total value of numeric values related to the same component, of numeric values indicated by the nutritional component information of each article,
wherein the display unit displays the total value calculated by the calculation unit together with the nutritional component information detected by the information specifying unit.

4. The apparatus according to claim 1, wherein the display unit displays a reference value for a nutritional component that should be taken per day together with the nutritional component information.

5. The apparatus according to claim 1, wherein the nutritional component information is information about at least one of calories, protein, fat, carbohydrate, and salt.

6. A shopping cart comprising:
a traveling unit which causes a housing unit for housing an article to travel;
a wireless communication unit which reads, from a wireless tag attached to an article located within the housing unit, information about the article via wireless communication;
an information specifying unit which specifies nutritional component information of the article to which the wireless tag is attached, on the basis of the information read from the wireless tag by the wireless communication unit; and
a display unit which displays the nutritional component information specified by the information specifying unit.

7. The shopping cart according to claim 6, wherein the information read from the wireless tag by the wireless communication unit includes nutritional component information, and
the information specifying unit specifies the nutritional component information included in information read from the wireless tag by the wireless communication unit, as the nutritional component information of the article to which the wireless tag is attached.

8. The shopping cart according to claim 6, further comprising a calculation unit which, if information is read from plural wireless tags by the wireless communication unit and nutritional component information of articles based on the information read from the plural wireless tags is specified by the information specifying unit, calculates a total value of numeric values related to the same component, of numeric values indicated by the nutritional component information of each article,
wherein the display unit displays the total value calculated by the calculation unit together with the nutritional component information detected by the information specifying unit.

9. The shopping cart according to claim 6, wherein the display unit displays a reference value for a nutritional component that should be taken per day together with the nutritional component information.

10. A nutritional component display method for displaying nutritional component information of an article on a display unit by using a wireless communication unit which reads information via wireless communication from a wireless tag located within a communication area, the method comprising:
reading, from a wireless tag attached to an article located within the communication area, information about the article by the wireless communication unit;
specifying nutritional component information of the article to which the wireless tag is attached, on the basis of the information read by the wireless communication unit; and
displaying the specified nutritional component information on the display unit.
